(19) United States
(12) Patent Application Publication
(10) Pub. No.: US 2013/0132223 A1
(43) Pub. Date: May 23, 2013

(54) MULTI-WIN AND RESERVE PRICE AUCTIONS ON ONLINE PAY TO BID AUCTIONS

(71) Applicant: TIMOTHY HANSON, West Liberty, KY (US)

(72) Inventor: TIMOTHY HANSON, West Liberty, KY (US)

(21) Appl. No.: 13/300,316

(22) Filed: Nov. 18, 2011

(51) Int. Cl. G06Q 30/08

(52) U.S. Cl. 705/26.3

(57) ABSTRACT

A method for conducting an online auction includes the steps of establishing a reserve price for an item and accepting pre-purchased bids from online bidders for the item. A value of all accepted bids for the item may be accumulated in a processor. The accumulated value may be published online. The item may be awarded to the bidder whose bid results in the accumulated value of bids being at least equal to the reserve price.

### BACKGROUND OF THE INVENTION

The present invention generally relates to online auctions and more particularly to such auctions in which bidders pre-purchase bidding rights.

In a typical pay to bid online auction system, a system operator may sell bids to be used in their auctions. Each bidder uses their bids to bid on an auction item that they are trying to win. An auction item is won by to the highest bidder when an auction timer ends. Typically, every bid adds time to the auction timer thereby giving more bidders an opportunity to bid and thus drive up the auction price. Adding time to the auction end time may allow bidders to go on indefinitely based on how much a bidder wants to spend towards the auction item.

Online pay to bid auction bidders do not win auctions based on skill, but rather how much money that a bidder is willing to bid on an auction item. These forms of online pay to bid auctions cater to the bidder who bids the highest or is the last bidder when the tinier runs out.

As can be seen, there is a need for an online pay to bid auction system in which bidders are entitled to use skill when bidding on an item which will level the field of bidders based on skill and not the wealth of an individual bidder.

### SUMMARY OF THE INVENTION

In one aspect of the present invention, A method for conducting an online auction may comprise the steps of: establishing a reserve price for an item; accepting pre-purchased bids from online bidders for the item, producing an accumulated value of all accepted bids for the item in a central computer; publishing the accumulated value online; and awarding the item to the bidder whose bid results in the accumulated value of bids being at least equal to the reserve price.

In another aspect of the present invention, an internet-based system for conducting an auction may comprise: a first online terminal configured to receive bids for an item from a plurality of online bidders; a processor connected to the terminal and configured to accumulate all bids made for the item; and a second online communications terminal connected to the processor and configured to receive an accumulated value of all bids for the item and to communicate the accumulated value and a reserve price for the item to any one of the online bidders upon request by the online bidder.

These and other features, aspects and advantages of the present invention will become better understood with reference to the following drawings, description and claims.

### BRIEF DESCRIPTION OF THE DRAWINGS

FIG. 1 is a flowchart of a method for conducting an online auction in accordance with an embodiment of the invention;

FIG. 2 is a flowchart of a method for conducting an online auction in accordance with another embodiment of the invention; and

FIG. 3 is a block diagram of an apparatus for conducting an online auction in accordance with an embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an online pay to bid auction system that establishes a pre-set reserve price for an item and then provides for an end of the auction when a bidder make a bid that meets the reserve price.

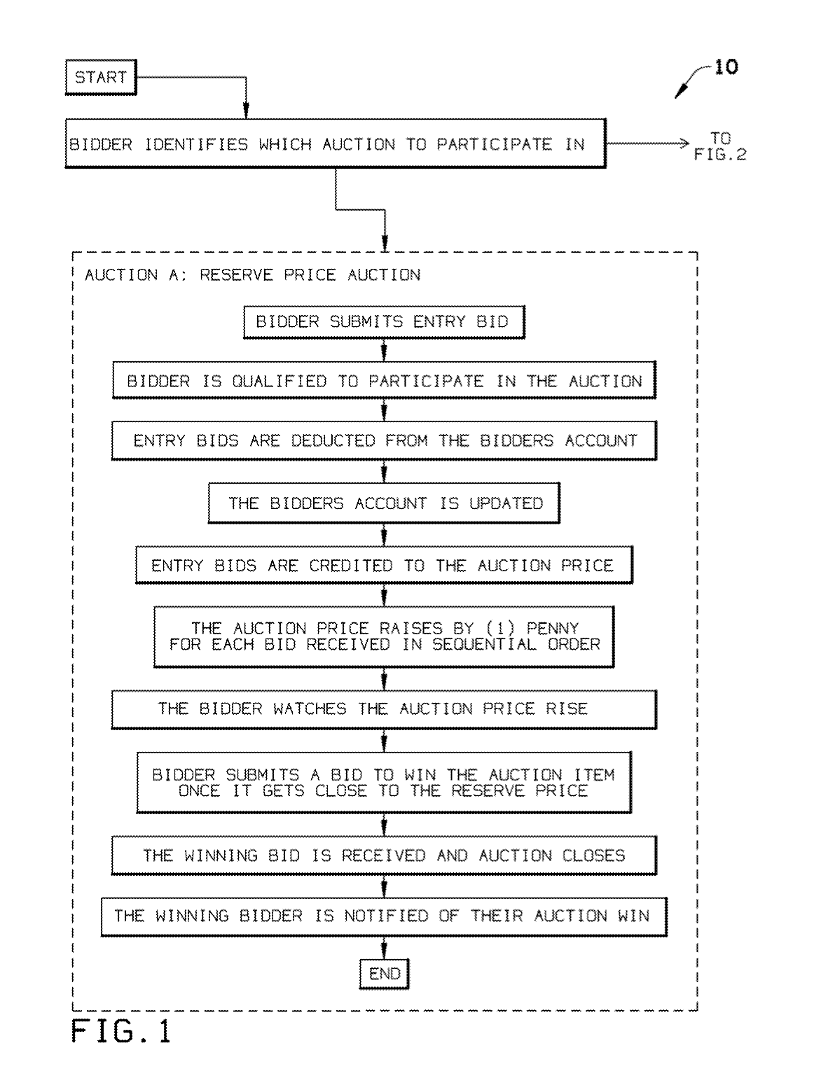

Referring now to the FIG. 1, exemplary embodiments of an auction method may be illustrated in a flow chart 100. A system operator may set, and publish on a web site, a reserve price for one or more items on which bids may be accepted. A prospective bidder may purchase bidding rights from the operator. For example, a prospective bidder may purchase 100 bids for $100 US. A bidder may select a particular item on which to bid and submit a minimum number of his or her purchased bids for entry into the auction. The minimum number of bids for entry may be determined by the operator. Entry bids from all persons bidding on a selected item may be accumulated in a central computer and the accumulated value of bids may be published on the website. This accumulated value may be referred to as a current auction price. Typically, each bid may be deemed, by the operator, to have a value of one cent ($0.01 US).

Individual bidders may make further post-entry bids. Such post-entry bidding may be subject to incremental limits established by the operator. For example, a bidder may be constrained to bid no more than 5 or 10 bids in a single transaction. As each bidding transaction is made, the bids may be added to the accumulated value of the current auction price and this current auction price may be published in real-time on the website of the operator.

Bidders may observe the current auction price and make judgments as to when to submit their respective bids so that their final bidding transaction may result in the current auction price being as high as the reserve price for the item.

When the current auction price equals the reserve price, the bidder whose bids produced that result is determined to be the winner and the item is awarded to that bidder. The bidder receives the item without any requirement to pay any additional money for the item. Thus the winner of the item may receive it for a cost that is no greater than an amount of money that the bidder paid to buy bidding rights from the operator.

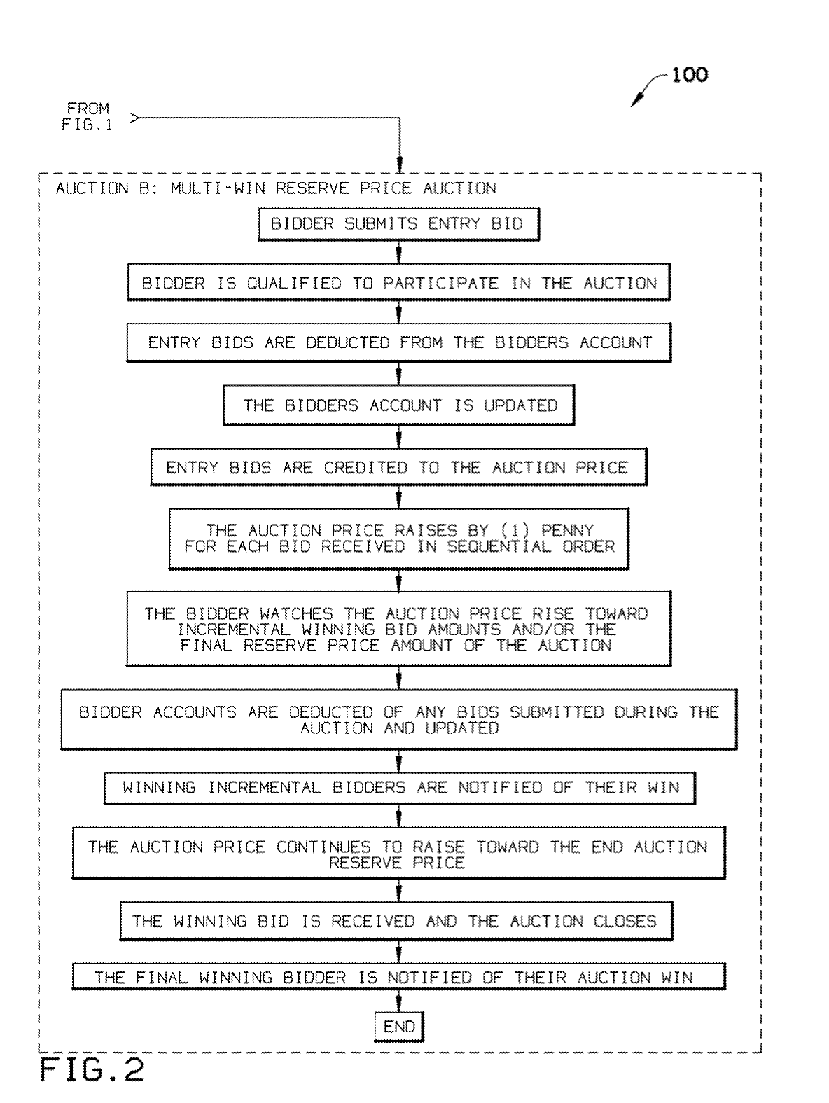

The auction method of the present invention may include a multi-win sub-method as illustrated in flowchart 100 of FIG. 2. Within the multi-win sub-method, the operator may establish various intermediate prize levels with incremental reserve prices lower than the reserve price of the item that is the subject of the main auction. The bids of each bidder may be accumulated relative to the incremental reserve prices just as they may be accumulated relative to the reserve price of the item. If and when a particular bidder's bid results in a meeting of one of the incremental reserve prices, that bidder may be awarded the incremental prize.

The winning bidder of an incremental prize (at one of the incremental reserve prices) may remain eligible to win a subsequent incremental prize and the final item that is the principal subject to the auction.

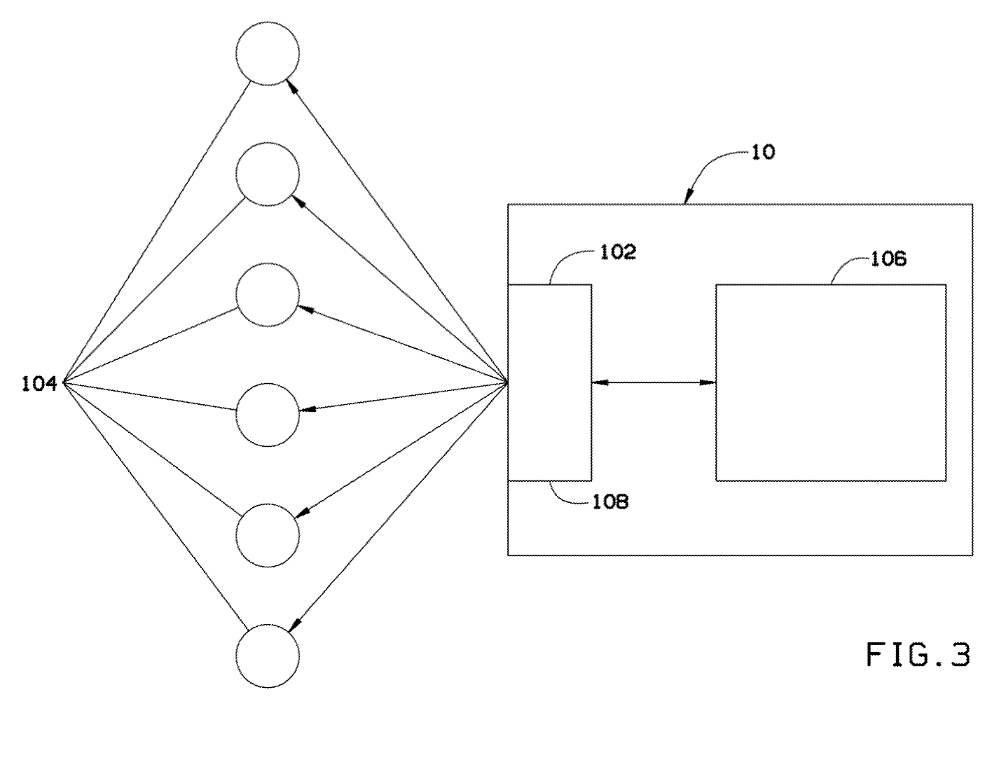

Referring now to FIG. 3, it may be seen that exemplary embodiment of an internet-based system 10 for conducting an auction may include a first online terminal 102. The terminal 102 may be configured to receive bids for an item from a plurality of online bidders 104. A processor 106 may be connected to the terminal 102 and configured to accumulate all bids made for the item. A second online communications terminal 102 may be connected to the processor 106 and configured to receive an accumulated value of all bids for the item and to communicate the accumulated value and a reserve price for the item to any one of the online bidders 104 upon request by the online bidder 104. In an exemplary embodiment the terminals 102 and 108 may be combined into a single unit.

It should be understood, of course, that the foregoing relates to exemplary embodiments of the invention and that modifications may be made without departing from the spirit and scope of the invention as set forth in the following claims.

What is claimed is:

1. A method for conducting an online auction comprising the steps of:
establishing a reserve price for an item;
accepting pre-purchased bids from online bidders for the item,
producing an accumulated value of all accepted bids for the item in a central computer;
publishing the accumulated value online; and
awarding the item to the bidder whose bid results in the accumulated value of bids being at least equal to the reserve price.

2. The method of claim 1 wherein the step of accepting bids is limited to a pre-determined number of bids accepted in any single online transaction.

3. The method of claim 1 wherein the accumulated value of accepted bids is determined on the basis of each bid having a value of $0.01 US.

4. The method of claim 1 wherein the step of accepting pre-purchased bids comprises:
accepting an entry bid from a bidder, and
accepting post-entry bids.

5. The method of claim 1 further comprising the steps of:
establishing one or more reserve prices for one or more incremental prizes;
accumulating the accepted bids relative the one or more incremental prizes simultaneously with accumulating the accepted bids relative to the item; and
awarding the one or more incremental prize to the bidder whose bid results in the accumulated value of bids being at least equal to the reserve price for the one or more incremental prizes.

6. An internet-based system for conducting an auction comprising;
a first online terminal configured to receive bids for an item from a plurality of online bidders;
a processor connected to the terminal and configured to accumulate all bids made for the item; and
a second online communications terminal connected to the processor and configured to receive an accumulated value of all bids for the item and to communicate the accumulated value and a reserve price for the item to any one of the online bidders upon request by the online bidder.

7. The apparatus of claim 6 wherein the processor is configured to accumulate all bids for one or more incremental prizes simultaneously with accumulating bids for the item.

8. The apparatus of claim 6 wherein the first online terminal is configured to receive bids from any one bidder in only a limited quantity for any one bidding transaction of said bidder.

9. The apparatus of claim 8 wherein the limited quantity is no greater than 10.

10. The apparatus of claim 6 wherein the processor is configured to accumulate all bids at a value of $0.01 per bid.
